(19) United States
(12) Patent Application Publication
(10) Pub. No.: US 2005/0266343 A1
(43) Pub. Date: Dec. 1, 2005

(54) Photoresist composition and method of forming same

(76) Inventors: Kyoung-Mi Kim, Gyeonggi-do (KR); Yeu-Young Youn, Seoul (KR); Youn-Kyung Wang, Gyeonggi-do (KR); Jae-Ho Kim, Gyeonggi-do (KR); Young-Ho Kim, Gyeonggi-do (KR); Boo-Deuk Kim, Gyeonggi-do (KR)

Correspondence Address: MARGER JOHNSON & MCCOLLOM, P.C., 210 SW MORRISON STREET, SUITE 400, PORTLAND, OR, 97204, US

(21) Appl. No.: 11/142,777

(22) Filed: May 31, 2005

(30) Foreign Application Priority Data
May 31, 2004 (KR) 2004-38900

(51) Int. Cl. G03C 1/492

(52) U.S. Cl. 430/270.1

(57) ABSTRACT

In a photoresist composition including a blocking group less sensitive to a temperature during a PEB process, the photoresist composition comprising from about 2% to about 10% by weight of a photosensitive resin, from about 0.1% to about 0.5% by weight of a photoacid generator, and a residual amount of a solvent, the photosensitive resin including a blocking group having a weight average molecular weight of from about 70 to about 130.

### CROSS-REFERENCE TO RELATED APPLICATION

This application relies for priority upon Korean Patent Application No. 2004-38900 filed on May 31, 2004, the content of which is herein incorporated by reference in its entirety.

### BACKGROUND OF THE INVENTION

1. Field of the Invention

The present invention relates to a photoresist composition and a method of forming same. It also relates to a method of forming a photoresist pattern using the photoresist composition.

2. Description of the Related Art

Semiconductor devices are highly integrated and operate at high speed. They have been required to form a very fine pattern having a line width which is no more than about 0.5 μm. Conventionally, a photolithography process using a photosensitive material such as a photoresist is typically utilized in forming a pattern for a semiconductor device. The photolithography process generally includes a photoresist coating process, an aligning process, an exposing process and a developing process.

The molecular structure of the photoresist, which is changed by light irradiated thereto, is coated on the substrate, such as a silicon wafer. This forms a photoresist film on the substrate by the photoresist coating process. Then, a photo mask on which an electronic circuit pattern is formed is arranged over the wafer on which the photoresist layer is formed during the aligning process. Then, an illuminating light has a particular wavelength to which the photoresist film is particularly sensitive. In this way, photochemical reactions will be incurred when illuminating light is irradiated onto the photo mask. Accordingly, a predetermined electronic circuit pattern can be transcribed onto the photoresist film by the aligning and exposing process. The molecular structures of the photoresist film are selectively changed in accordance with the predetermined electronic circuit pattern. The developing process selectively removes the photoresist film having the changed molecular structures thereby forming a photoresist pattern on the substrate.

A minimal line width of the photoresist pattern or the semiconductor pattern is determined in accordance with a resolution of an exposing system. The resolution of the exposing system is determined by the wavelength of the illumination light according to Rayleigh's equation as follows:
R=K₁λ/NA (1)

In this Rayleigh's equation, λ denotes a wavelength of the illumination light of an exposing system, R denotes a resolution limit of an exposing system, K₁ denotes a proportional constant of an exposing process, and NA denotes a numerical aperture of a lens of an exposing process. According to the Rayleigh's equation, the wavelength λ of the illumination light and the proportional constant K₁ need to be as small as possible, and the numerical aperture of a lens needs to be as large as possible for decreasing the resolution limit of an exposing system. Thus, the higher the resolution of the exposing system, the shorter the wavelength of the illumination light. That is, the wavelength of the illumination light needs to be reduced in order to form a fine photoresist pattern. Among the factors of the Rayleigh's equation, the wavelength λ of the illumination light is most widely utilized for increasing the resolution limit of an exposing system.

In early 1980s, a G-line light having a wavelength of about 436 nm or an I-line light having a wavelength of about 365 nm were exemplarily used as the illumination light, and the photoresist pattern was formed having a resolution of from about 350 to about 500 nm. Recently, a krypton fluoride (KrF) excimer laser having a wavelength of about 248 nm, or an argon fluoride (ArF) excimer laser having a wavelength of about 193 nm, were used as the illumination light, and a photoresist pattern has been formed having a resolution of about 180 to about 240 nm. A memory device of a few giga-bytes is now possible to be manufactured having the above-referenced fine photoresist pattern (as disclosed in Solid State Technology, January, 2000).

The fine photoresist pattern influenced to a great extent by a wavelength of the illumination light, and the exposition system including the illumination light, and the resolution limit of the exposition system. The use of photoresist is generally described in the articles entitled “Photoresist Materials and Processes” by DeForest, McGraw Hill Book Company, New York (1975), and “Semiconductor Lithography, Principles, Practices and Materials” by Moreau, Plenum Press, New York (1988).

The photoresist is mainly classified as a negative type and a positive type in accordance with a molecular reaction to light irradiated thereto. When the positive photoresist is exposed to light, an acid is liberated from a photo acid generator (PAG) in an exposed portion of the positive photoresist. The acid liberated from the PAG dissociates a particular blocking group from a photosensitive resin of the photoresist, which is widely known as a de-blocking.

A large quantity of energy is required for the above de-blocking process, and this required energy is known in the art as activation energy. Until now, a stronger photo acid was liberated or a post etching baking process was performed at a higher temperature for providing a greater activation energy.

The light energy is inversely proportional to a wavelength thereof, and thus an ArF excimer laser or a KrF excimer laser has a very high light energy. Accordingly, when the ArF excimer laser or the KrF excimer laser is used for exposing the photoresist layer, the blocking group has much more of an effect on differential solubility characteristics between exposed and unexposed areas of the photoresist layer formed on the substrate.

Many different blocking groups are disclosed in the prior art.

For example, U.S. Pat. No. 5,558,971 discloses a photoresist including a blocking group which is sensitive to DUV light. The blocking group is an acetal or a ketal of a formula “—OCR₁R₂OR₃”, wherein R1 and R2 are a hydrogen atom, a straight-chain, branched or cyclic alkyl group having 1-6 carbon atoms, a straight-chain or branched haloalkyl group having 1-6 carbon atoms, or a phenyl group, provided that R1 and R2 are not hydrogen at the same time, or R1 and R2 may combine to form a methylene chain having 2-5 carbon atoms, and R3 may be a straight chain, branched or cyclic alkyl group having 1-10 carbon atoms, a straight-chain, branched or cyclic haloalkyl group having 1-6 carbon atoms, an acetyl group or an aralkyl group. The above photoresist has a problem that de-blocking of the blocking group may randomly occur during storage of the photoresist in a container. That is, the photoresist has a disadvantage in that its storage stability is very low.

To improve the low storage stability, U.S. Pat. No. 5,362,600 discloses a photoresist including blocking groups that require greater activation energy. The blocking group conforms to the formula “—CR₄R₅C(═O)OR₆”, wherein each of R4 and R5 is selected from hydrogen, an electron withdrawing group such as halogen, lower alkyl having 1 to about 10 carbon atoms, and a substituted lower alkyl having 1 to about 10 carbon atoms, and R6 is a substituted or unsubstituted lower alkyl having 1 to about 10 carbon atoms, a substituted or unsubstituted aryl having 1 to about 10 carbon atoms, and a substituted or unsubstituted benzyl having 7 to about 10 carbon atoms.

For the high-energy blocking groups described above, the required activation energy is within a range of from about 25 Kcal/mole to about 40 Kcal/mole. Furthermore, to enable de-blocking to occur, it is necessary to use one or both of a photo acid generator capable of liberating a strong acid and/or a high temperature post exposure bake (PEB) typically at a temperature of about 130° C. or higher.

For reasons set forth above, the photoresists using the blocking groups requiring high activation energy are generally subjected to one and often two high temperature baking steps. When performing the high temperature baking steps, it has been found that minor variations in the bake temperature, for example, variations of ±1° C., across a width of the photoresist layer on the substrate may lead to a significant variation in line width of a photoresist pattern and that this variation increases with increased bake temperature. This sensitivity is referred to in the art as PEB sensitivity. The PEB sensitivity is defined as changes in line width of a pattern at a fixed exposure dose on wafers that are post-exposure baked at increasing temperatures.

There is a problem in that a residual photoresist remains on a bottom surface of a photoresist pattern which is referred to in the art as a footing phenomenon or a scrum. This is when the photoresist pattern is formed having a line width less than or equal to about 85 nm using a high temperature post exposure baking process at a temperature of about 130° C. or higher. In addition, the PEB sensitivity is deteriorated due to a volume variation of the blocking group when a photoresist that includes a blocking group comprising elements having a molecular weight more than or equal to about 130 and which is also sensitive to an ArF excimer laser patterned to be a photoresist pattern having a line width less than or equal to about 85 nm.

### SUMMARY OF THE INVENTION

Accordingly, the present invention provides a photoresist composition for patterning a fine photoresist pattern having a uniform line width and a good pattern profile.

The present invention also provides a method of forming a pattern on a substrate using the above photoresist composition.

According to an exemplary embodiment of the present invention, there is provided a preferred photoresist composition coated on an object to be patterned. The photoresist composition comprises from about 2% to about 10% by weight of a photosensitive resin, from about 0.1% to about 0.5% by weight of a photo acid generator, and a residual of a solvent, and the photosensitive resin includes a blocking group having a weight average molecular weight of from about 70 to about 130. As a further embodiment, the blocking group comprises from about six to eight carbon atoms, and the blocking group utilizes activation energy (Ea) of no more than about 20 kcal/mol.

According to another exemplary embodiment of the present invention, there is provided a method of forming a pattern using the above photoresist composition. A photoresist composition is preferably provided comprising from about 0.1% to about 0.5% by weight of a photo acid generator, from about 2% to about 10% by weight of a photosensitive resin, and a residual of a solvent, and the photosensitive resin includes a blocking group having a weight average molecular weight of from about 70 to about 130. A photoresist film is formed on an object by coating the photoresist composition thereon. The photoresist film is selectively exposed to an illumination light, preferably having a short wavelength. The exposed photoresist film is developed by a conventional developing process to thereby form a photoresist pattern.

As an exemplary embodiment, the blocking group can have a weight average molecular weight of about 80 to about 120, and can also comprise six to eight carbon atoms. The blocking group utilizes an activation energy (Ea) of no more than about 20 kcal/mol. Examples of the photosensitive resin may include a methacrylate resin, a vinyl ether methacrylate (VEMA) resin, a cyclo-olefin methacrylate (COMA) resin, etc. Examples of a photoacid generator may include a monophenyl sulfonium, a diphenyl sulfonium, a triphenyl sulfonium, etc. These can be used alone or in a combination with each other. Examples of the solvent may include propylene glycol monomethyl ether acetate, methyl 2-hydroxyisobutyrate, ethyl lactate, cyclohexanone, heptanone, etc. These can be used alone or in a combination with each other. The object can include a silicon substrate on which an anti-reflection layer is formed, an insulation layer on which an anti-reflection layer is formed, a polysilicon layer on which an anti-reflection layer is formed, or a conductive layer on which an anti-reflection layer is formed. The illumination light may have a wavelength of no more than about 193 nm. A post exposure baking process may be further performed after selectively exposing the photoresist film at a temperature of between about 95° C. and about 115° C., and the object exposed through the photoresist pattern may be partially further etched.

According to an aspect of the present invention, the photoresist pattern has no residual photoresist on a bottom portion thereof, and the post exposure baking process is less sensitive to a temperature to thereby have a uniform line width and a good profile without anfractuosities.

### BRIEF DESCRIPTION OF THE DRAWINGS

The above and other features and advantages of the present invention will become readily apparent by reference to the following detailed description when considering in conjunction with the accompanying drawings, in which:

FIGS. 1 to 3 are cross sectional views illustrating a method of forming a pattern using the photoresist composition of the present invention;

FIG. 4 is a scanning electron microscope (SEM) picture of a vertical profile of the first photoresist pattern; and

FIG. 5 is a SEM picture of a vertical profile of a comparative photoresist pattern.

### DESCRIPTION OF THE PREFERRED EMBODIMENTS

The present invention now will be described more fully hereinafter with reference to the accompanying drawings in which exemplary embodiments of the present invention are shown.

In one embodiment, a photoresist composition of the present invention comprises a photosensitive polymer that is coated on an object to be patterned. Exemplarily materials can include a photoacid generator for generating an acid, a photosensitive resin selectively reactive to light and a residual of a solvent.

The photosensitive resin in the photoresist composition can include a blocking group, an adhesion group, a wetting group and an etching resistance compensation group.

The blocking group associates with the photosensitive resin of the photoresist composition, and is dissociated from the photosensitive resin by an acid generated from the photoacid generator (PAG) employing a predetermined quantity of activation energy.

In the present invention, the blocking group has a weight average molecular weight of about 70 to about 130. When the blocking group has a weight average molecular weight less than about 70, it is difficult for the photoresist comprising the photoresist composition of the present invention to be patterned into a photoresist pattern. In addition, when the blocking group has a weight average molecular weight more than about 130, the PEB sensitivity is increased so that a line width of the photoresist pattern becomes substantially varied with a relatively small variation in the temperature of the post exposure bake.

Accordingly, the blocking group preferably has a weight average molecular weight of about 70 to about 130, and more preferably has a weight average molecular weight of about 80 to about 120.

The blocking group requires a predetermined quantity of activation energy for dissociation from the photosensitive resin. A means to determine activation energy is described by Wallraff et al., Kinetics of Chemically Amplified Resists, photopolymers principles, processes, and materials, Tenth International Technical Conference, pp. 11-17, Oct. 31-Nov. 2, 1994, Society of Plastic Engineers, Inc. and by Wallraffet al., J. Vac. Sci. Technol., 1995, 12(6) 3857. Activation energy is expressed in units of Kcal/mol.

In the present invention, when the activation energy for dissociating the blocking group from the photosensitive resin is more than about 20 Kcal/mol, a line width of the photoresist pattern is substantially varied. Thus, the activation energy is preferably no more than about 20 Kcal/mol.

The photoresist composition of the present invention includes about 2% to about 10% by weight of the photosensitive resin having the above blocking group. When the photosensitive resin is less than about 2% by weight based on a total weight of the photoresist composition, the photoresist comprising the photoresist composition of the present invention has difficulty being pattered into a photoresist pattern. When the photosensitive resin is more than about 10% by weight based on a total weight of the photoresist composition, the photoresist comprising the photoresist composition of the present invention is not uniformly coated onto a surface of an object, so that the photoresist film is not uniformly formed on the object. Accordingly, when the photosensitive resin is more than about 10% by weight based on a total weight of the photoresist composition, the photoresist pattern will typically not have a uniform line width. Accordingly, the photoresist composition of the present invention preferably includes about 2% to about 10% by weight of the photosensitive resin, and more preferably includes about 3% to about 9% by weight of the photosensitive resin.

Examples of the photosensitive resin include an acrylate-based resin, a cyclo-olefin methacrylate (COMA)-based resin, a cyclo-olefin (CO)-based resin, etc. More preferably, the photosensitive resin includes a methacrylate resin, a vinyl ether methacrylate (VEMA) resin, a COMA resin, etc. These can be used alone or in combination. The photosensitive resin including the above blocking group is not limited to the above exemplary materials. Furthermore, a material can function as a photosensitive resin if it is not reacted with the solvent and has a sufficient solubility and evaporation rate such that a uniform deposition layer can be formed on a substrate after the solvent is fully evaporated.

The blocking group requires both an acid having a predetermined strength and a predetermined amount of heat for dissociation from the photosensitive resin as well as for providing the activation energy.

The strength of the acid is determined by an amount of hydrogen ions (H+) liberated from the PAG. The hydrogen ions (H+) are liberated from the PAG when light is irradiated. The photoacid generator of the present invention comprises about 0.1% to about 0.5% by weight based on a total weight of the photoresist composition.

When the photo acid generator is present in an amount less than about 0.1% by weight based on a total weight of the photoresist composition, the hydrogen ions (H+) are less sufficiently liberated from the PGA by illumination light during an exposing process, and thus the strength of the acid is reduced according to the Arrhenius theory. Accordingly, the blocking group is less dissociated from the photosensitive resin. In contrast, when the photoacid generator is present in an amount which is more than about 0.5% by weight based on a total weight of the photoresist composition, the hydrogen ions (H+) are excessively liberated from the PGA by the illumination light during an exposing process, and thus the strength of the acid is excessively increased according to the Arrhenius theory. Accordingly, a top portion of an exposed photoresist layer is excessively broken away and lost during the developing process (hereinafter referred to as top loss of a pattern).

Accordingly, the photoresist composition preferably includes about 0.1% to about 0.5% by weight of the photoacid generator, and more preferably, includes about 0.15% to about 0.4% by weight of the photoacid generator.

In the present invention, the photoacid generator preferably includes a monophenyl sulfonium, a diphenyl sulfonium, a triphenyl sulfonium or a mixture thereof. These materials can be used alone or in combinations thereof. Examples of these monophenyl sulfonium include triphenyl sulfonium triflate, triphenyl sulfonium nonaflate, triphenyl sulfonium perfluorooctanesulfonates, etc.

The monophenyl sulfonium has a higher transmissivity and a lower acid generation rate as compared with the diphenyl sulfonium. That is, the monophenyl sulfonium has relatively small absorbance compared with the diphenyl sulfonium, and a lesser amount of the hydrogen ions (H+) are generated from the monophenyl sulfonium than the diphenyl sulfonium. In the same way, the diphenyl sulfonium has a higher transmissivity and a lower acid generation rate as compared with the triphenyl sulfonium.

The heat for dissociation of the blocking group from the photosensitive resin is supplied during a post exposure baking process performed after the exposing process is completed. The heat is preferably provided at a temperature of from about 95° C. up to about 115° C. When the heat is supplied at a temperature below about 95° C., the blocking group is hardly dissociated from the photosensitive resin, and when the heat is supplied at a temperature above about 115° C., the line width of a photoresist pattern becomes substantially non-uniform.

The photoresist composition of the present invention comprises a solvent for dissolving the photosensitive resin and the PAG. Examples of the solvent include propylene glycol monomethyl ether (PGMEA), methyl 2-hydroxyisobutyrate (HBM), ethyl lactate (EL), cyclohexanone, heptanone, lactone, etc. These can be used alone or in combination thereof.

The photoresist film including the blocking group is less sensitive to temperature changes during the PEB process for patterning the photoresist film, and the photoresist scarcely remains on the bottom portion of the photoresist pattern after the photoresist pattern is completed. As described above, the sensitivity of the photoresist film with respect to a temperature of the PEB process is known as the PEB sensitivity, which is defined as changes in line width of a pattern at a fixed exposure dose on wafers that are post-exposure baked at increasing temperatures. The measured line width of each wafer is plotted against the PEB temperature and the PEB sensitivity in nm/° C. which forms the slope of the line plotted.

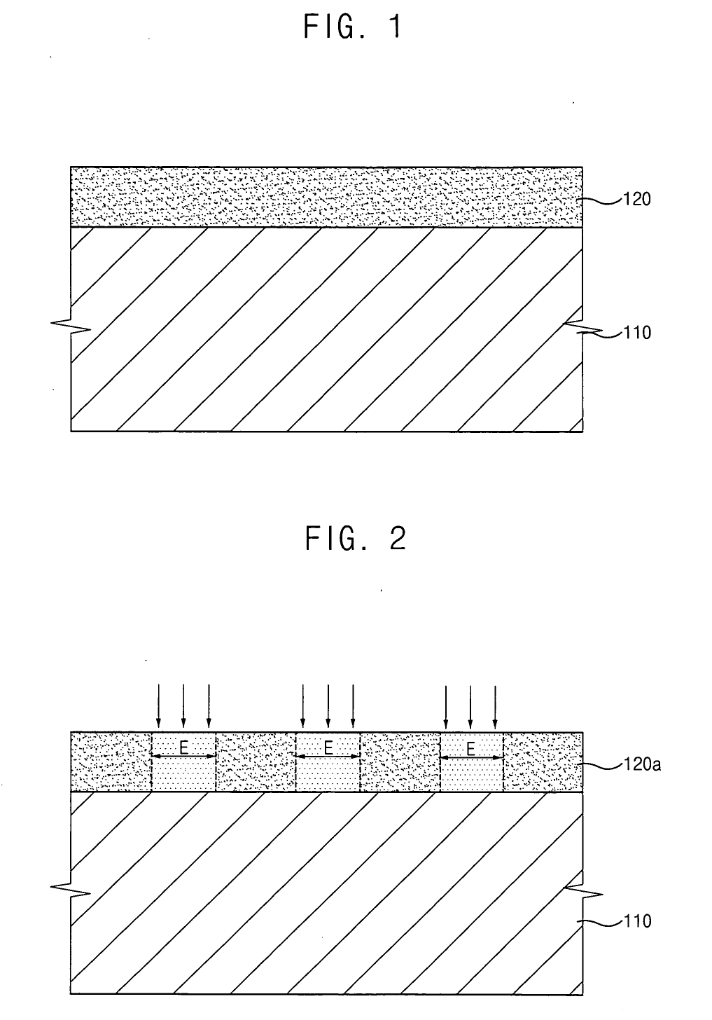

Hereinafter, a method of forming an insulation pattern having a line width no more than about 85 nm using the above photoresist composition of the present invention will be described in detail with reference to FIGS. 1 to 3. FIGS. 1 to 3 are cross sectional views illustrating a method of forming a pattern using the photoresist composition of the present invention.

Referring to FIG. 1, a preferred photoresist composition is prepared to comprise from about 0.1% to about 0.5% by weight of a photoacid generator, from about 2% to about 10% by weight of a photosensitive resin and a residual of a solvent, and the photosensitive resin includes a blocking group having a weight average molecular weight of from about 70 to about 130. Then, the photoresist composition is coated on an object 110 to be patterned, and a soft baking process is performed on the object 110 to thereby form a photoresist film 120. In the present embodiment, the blocking group in the preferred photosensitive resin has a preferable weight average molecular weight of from about 80 to about 120, and has six to eight carbon atoms. In addition, the preferred blocking group requires an activation energy of no more than about 20 Kcal/mol. The blocking group requires a predetermined strength of an acid and a predetermined amount of heat for dissociation from the photosensitive resin. The photoresist composition is fully and sufficiently described above, thus further description on the photoresist composition is omitted.

The soft baking is performed on the photoresist film 120 at a temperature of from about 90° C. to about 120° C. for reinforcing an adhering force of the photoresist composition to the substrate and for evaporating a solvent in the photoresist composition.

Examples of the object 110 include a silicon substrate on which an anti-reflection layer is formed, an insulation layer on which an anti-reflection layer is formed, a polysilicon layer on which an anti-reflection layer is formed, and an amorphous silicon carbide layer on which an anti-reflection layer is formed. In the present embodiment, the insulation layer includes a silicon oxide-based insulation layer such as boron phosphorus silicate glass (BPSG) layer, and the polysilicon layer is doped with impurities.

Referring to FIG. 2, a reticle (not shown) on which a mask pattern is formed in accordance with an electronic circuit is positioned over the photoresist film 120. An illumination light is irradiated onto the reticle. The illumination light passes through the reticle in accordance with the mask pattern, and is projected onto the photoresist film 120. Accordingly, the photoresist film 120 is selectively exposed to the illumination light in accordance with the mask pattern, so that the electronic circuit is transferred and downsized onto the photoresist film 120 with a predetermined reduction ratio to thereby form an exposed photoresist film 120a including some exposed areas E. A polymer bond in the photosensitive resin is broken in the exposed area E of the exposed photoresist film 120a.

The photoresist composition is preferably sensitive to illumination light having a preferred wavelength of not more than about 240 nm. In the present embodiment, the photoresist composition is more sensitive to the illumination light having a preferred wavelength of not more than about 193 nm, such as an ArF excimer laser. However, the illumination light should not be limited to the ArF excimer laser, and may have another light source having a wavelength different from that of the ArF excimer laser based on the processing conditions.

Referring to FIG. 3, a post baking is performed on the substrate including the exposed photoresist film 120a, and the exposed photoresist film 120a is developed using a conventional developing process to thereby form a photoresist pattern 130 having a line width P no more than about 85 nm. The post baking is performed for reducing the amount of residual solvent remaining in the photoresist film 120. The exposed area E of the exposed photoresist film 120a is dissolved into a developing solution having high solubility with respect to the exposed photoresist film 120a, and thus the exposing area E of the exposed photoresist film 120a is removed from the substrate to thereby form the photoresist pattern 130 on the substrate. A cleaning process for removing a residual developing solution remaining on the substrate may be subsequently performed.

The above photoresist pattern on the substrate has a profile substantially perpendicular to a top surface of the silicon substrate without anfractuosities, and has a uniform line width on a whole substrate. A footing phenomenon is not observed at a bottom portion of the first photoresist pattern, and thus no residual photoresist compositions remain on the bottom surface of the photoresist pattern 130 after the photoresist pattern is completed.

A hard baking process is performed on the substrate including the photoresist pattern 130, and a portion of the anti-reflection layer and a top portion of the silicon substrate, which are exposed through the photoresist pattern, are partially removed by a dry etching process using the photoresist pattern as an etching mask to thereby form a silicon pattern on the silicon substrate. Then, a residual photoresist pattern and the anti-reflection layer remaining on the substrate are removed after completing the dry etching process for the silicon pattern.

Hereinafter, various examples and comparative examples will be provided for describing the present invention in more detail. The various examples provided below are exemplary examples of the present invention, and thus the present invention should not be limited to these exemplary examples.

### EXAMPLE 1

About 70 weight parts of a methacrylate resin, about 10 weight parts of a quencher, about 25 weight parts of a photoacid generator and about 895 weight parts of a solvent were mixed with one another to thereby form a first solution.

The methacrylate resin in the first solution includes a blocking group having a weight average molecular weight of about 80 to about 90. The first solution was filtered through a membrane filter of about 0.2 μm, to thereby obtain a first photoresist composition sensitive to an ArF excimer laser.

### EXAMPLE 2

About 70 weight parts of a methacrylate resin, about 10 weight parts of a quencher, about 25 weight parts of a photo acid generator and about 895 weight parts of a solvent were mixed with one another to thereby form a second solution.

The methacrylate resin in the second solution includes a blocking group having a weight average molecular weight of about 90 to about 100. The second solution was filtered through a membrane filter of about 0.2 μm, to thereby obtain a second photoresist composition sensitive to an ArF excimer laser.

### EXAMPLE 3

About 70 weight parts of a methacrylate resin, about 10 weight parts of a quencher, about 25 weight parts of a photoacid generator and about 895 weight parts of a solvent were mixed with one another to thereby form a third solution.

The methacrylate resin in the third solution includes a blocking group having a weight average molecular weight of about 100 to about 110. The third solution was filtered through a membrane filter of about 0.2 μm, to thereby obtain a third photoresist composition sensitive to an ArF excimer laser.

### COMPARATIVE EXAMPLE 1

About 70 weight parts of a methacrylate resin, about 10 weight parts of a quencher, about 25 weight parts of a photoacid generator and about 895 weight parts of a solvent were mixed with one another to thereby form a first comparative solution. The methacrylate resin in the first comparative solution includes a blocking group having a weight average molecular weight of about 145 to about 155. The first comparative solution was filtered through a membrane filter of about 0.2 μm, to thereby obtain a first comparative photoresist composition sensitive to an ArF excimer laser.

### COMPARATIVE EXAMPLE 2

About 70 weight parts of a methacrylate resin, about 10 weight parts of a quencher, about 25 weight parts of a photo acid generator and about 895 weight parts of a solvent were mixed with one another to thereby form a second comparative solution. The methacrylate resin in the second comparative solution includes a blocking group having a weight average molecular weight of about 160 to about 175. The second comparative solution was filtered through a membrane filter of about 0.2 μm, to thereby obtain a second comparative photoresist composition sensitive to an ArF excimer laser.

### EXPERIMENT 1

The first photoresist composition was coated onto a BPSG layer, and a baking process was performed to thereby form a first photoresist film to a thickness of about 1200 Å. Then, an ArF excimer laser was projected (or illuminated) onto the first photoresist film through a reticle that is positioned over the first photoresist film including a mask pattern corresponding to an electronic circuit. Accordingly, the first photoresist film was selectively exposed to the ArF excimer laser in accordance with the mask pattern. A soft baking process, a developing process and a hard baking process were sequentially performed on the exposed first photoresist film to thereby form a first photoresist pattern having a line width of about 83 nm. Then, the first photoresist pattern was observed using an electron microscope, and a picture of a vertical profile of the first photoresist pattern was obtained.

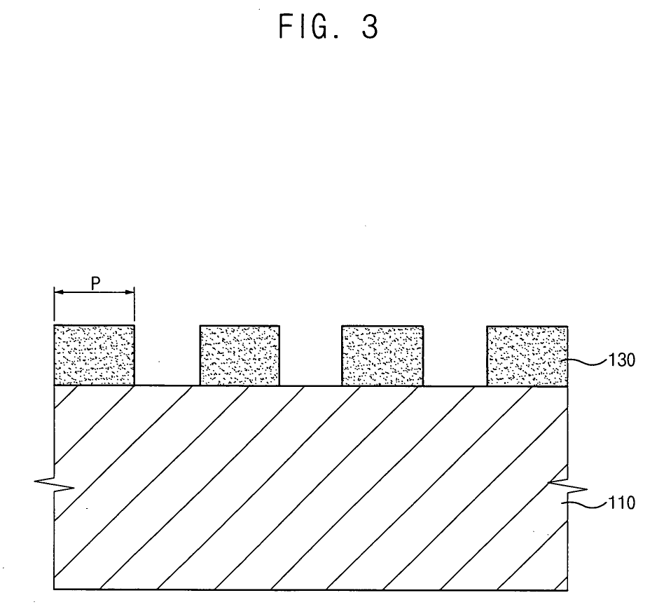

FIG. 4 is a scanning electron microscope (SEM) picture of a vertical profile of the first photoresist pattern. As shown in FIG. 4, the first photoresist pattern on the BPSG layer had a profile substantially perpendicular to a top surface of the substrate layer and has a uniform line width. The footing phenomenon was not observed at a bottom portion of the first photoresist pattern, and thus no residual photoresist composition remained on the bottom surface of the first photoresist pattern. Further, a top portion of first photoresist pattern was not broken away.

### COMPARATIVE EXPERIMENT 1

The first comparative photoresist composition was coated onto a BPSG layer, and a baking process was performed to thereby form a first comparative photoresist film to a thickness of about 1200 Å. Then, the ArF excimer laser was illuminated onto the first comparative photoresist film through a reticle positioned over the first comparative photoresist film and including a mask pattern. Accordingly, the first comparative photoresist film was selectively exposed to the ArF excimer laser in accordance with the mask pattern. A soft baking process, a developing process and a hard baking process were sequentially performed on the exposed first comparative photoresist film to thereby form a first comparative photoresist pattern. Then, the first comparative photoresist pattern was observed using an electron microscope, and a picture of a vertical profile of the first comparative photoresist pattern was obtained.

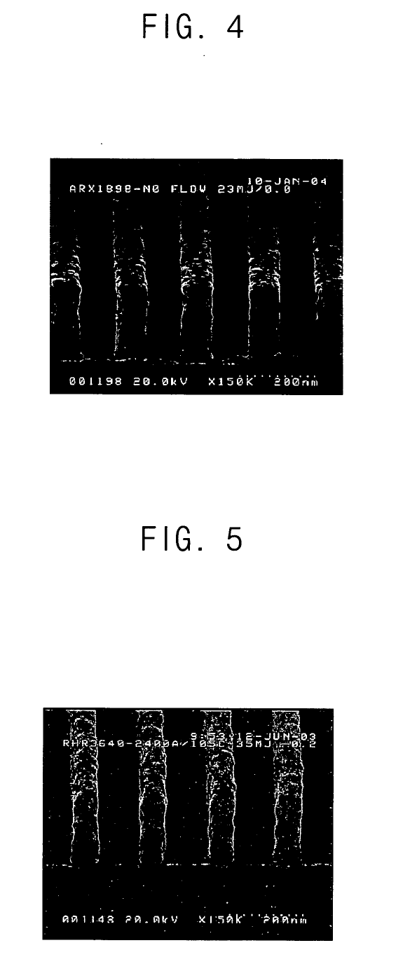

FIG. 5 is a SEM picture of a vertical profile of the first comparative photoresist pattern. The blocking group in the first comparative photoresist composition was so sensitive to heat that residual photoresist composition remained on a bottom surface of the first comparative photoresist pattern as shown in FIG. 5. In addition, a line width of the first comparative photoresist pattern was distinctively varied regardless of the blocking group being dissociated from a photosensitive resin of the first comparative photoresist composition according to the variation of heat. Accordingly, the first comparative photoresist pattern was shown to have an unacceptable pattern profile.

### EXPERIMENT 2

The BPSG layer was partially etched away using the first photoresist pattern as an etching mask, so that a BPSG pattern was formed on a substrate having various line widths in accordance with an activation energy, as shown in Table 1.

TABLE 1

| | Activation energy (J) | | | | |
|---|---|---|---|---|---|
| | 130 | 135 | 145 | 150 | 155 |
| Ave. Line width (nm) | 92.5 | 87.4 | 84.1 | 81.7 | 79.5 |
| Max. Line width (nm) | 99.2 | 99.8 | 88.1 | 86.5 | 82.9 |
| Min. Line width (nm) | 86.7 | 83.4 | 80.5 | 78.6 | 76.5 |
| Deviation of line widths | 9.5 | 7.88 | 4.24 | 4.10 | 4.41 |

As shown in Table 1, the line widths of the BPSG pattern are no more that about 85 nm in case the activation energy is higher than about 145 J. In addition, the deviation of the line widths is below about 4.5, which is satisfactory in view of the uniformity of the line width.

### COMPARATIVE EXPERIMENT 2

The BPSG layer was partially etched away using the first comparative photoresist pattern as an etching mask, so that a BPSG pattern was formed on a substrate having various line widths in accordance with an activation energy in a similar way to Experiment 2, as shown in Table 2.

TABLE 2

| | Activation energy (J) | | | | |
|---|---|---|---|---|---|
| | 170 | 175 | 180 | 185 | 190 |
| Ave. Line width (nm) | 85.3 | 82.5 | 79.3 | 76.5 | 75.4 |
| Max. Line width (nm) | 91.8 | 87.5 | 84.4 | 81.6 | 79.0 |
| Min. Line width (nm) | 81.1 | 77.7 | 72.9 | 72.0 | 71.0 |
| Deviation of line widths | 6.27 | 6.76 | 11.5 | 6.22 | 6.01 |

As shown in Table 2, the line widths of the BPSG pattern are also no more than about 85 nm in case the activation energy is higher than about 170 J. However, the deviation of the line widths is over about 6.0, which is not satisfactory in view of the uniformity of the line width.

According to the present invention, the photoresist composition of the present invention is less sensitive to a temperature during a PEB process, so that the photoresist pattern has no residual photoresist on a bottom portion thereof, and has a uniform line width and a good profile without anfractuosities.

Therefore, the photoresist pattern comprising the photoresist compositions of the present invention improves a reliance of a semiconductor device, so that manufacturing cost and time are sufficiently reduced. In particular, when the photoresist compositions of the present invention are applied to manufacturing processes of a next generation semiconductor device, reduction of the manufacturing cost and time may be more remarkable and prominent.

Although the exemplary embodiments of the present invention have been described, it is understood that the present invention should not be limited to these exemplary embodiments but various changes and modifications can be made by one skilled in the art within the spirit and scope of the present invention as hereinafter claimed.

1. A photoresist composition comprising from about 2% to about 10% by weight of a photosensitive resin, from about 0.1% to about 0.5% by weight of a photoacid generator, and a residual amount of a solvent, the photosensitive resin including a blocking group having a weight average molecular weight of from about 70 to about 130.

2. The photoresist composition of claim 1, wherein the blocking group comprises a weight average molecular weight of from about 80 to about 120.

3. The photoresist composition of claim 1, wherein the blocking group comprises six to eight carbon atoms.

4. The photoresist composition of claim 1, wherein the blocking group utilizes an activation energy (Ea) of not more than about 20 kcal/mol.

5. The photoresist composition of claim 1, wherein the photosensitive resin comprises methacrylate resin, vinyl ether methacrylate (VEMA) resin or cyclo-olefin methacrylate (COMA) resin.

6. The photoresist composition of claim 1, wherein the photoacid generator comprises one compound selected from the group consisting of a monophenyl sulfonium, a diphenyl sulfonium, a triphenyl sulfonium, and combinations thereof.

7. The photoresist composition of claim 1, wherein the solvent comprises one compound selected from the group consisting of propylene glycol monomethyl ether acetate, methyl 2-hydroxyisobutyrate, ethyl lactate, cyclohexanone, heptanone, and combinations thereof.

8. A method of forming a pattern, comprising;
preparing a photoresist composition including from about 0.1% to about 0.5% by weight of a photo acid generator, from about 2% to about 10% by weight of a photosensitive resin, and a residual of a solvent, the photosensitive resin including a blocking group having a weight average molecular weight of from about 70 to about 130;
forming a photoresist film on an object by coating the photoresist composition;
selectively exposing the photoresist film using an illumination light; and
developing the selectively exposed photoresist film to thereby form a photoresist pattern.

9. The method of claim 8, wherein the blocking group has a weight average molecular weight of from about 80 to about 120.

10. The method of claim 8, wherein the blocking group utilizes an activation energy (Ea) of not more than about 20 kcal/mol.

11. The method of claim 8, wherein the photosensitive resin comprises a methacrylate resin, a vinyl ether methacrylate (VEMA) resin or a cyclo-olefin methacrylate (COMA) resin.

12. The method of claim 8, wherein the photoacid generator comprises at least one compound selected from the group consisting of a monophenyl sulfonium, a diphenyl sulfonium and a triphenyl sulfonium.

13. The method of claim 8, wherein the solvent comprises at least one compound selected from the group consisting of propylene glycol monomethyl ether acetate, methyl 2-hydroxyisobutyrate, ethyl lactate, cyclohexanone and heptanone.

14. The method of claim 8, wherein the object comprises a silicon substrate on which an anti-reflection layer is formed, an insulation layer on which an anti-reflection layer is formed, a polysilicon layer on which an anti-reflection layer is formed, or a conductive layer on which an anti-reflection layer is formed.

15. The method of claim 8, wherein the illumination light has a wavelength no more than about 193 nm.

16. The method of claim 8, further comprising performing a post exposure baking process after selectively exposing the photoresist film.

17. The method of claim 16, wherein the post exposure baking process is performed at a temperature between about 95° C. and about 115° C.

18. The method of claim 8, further comprising partially etching the object exposed through the photoresist pattern.

19. The method of claim 8, wherein the blocking group comprises six to eight carbon atoms

20. A method of forming a pattern, comprising;
preparing a photoresist composition including from about 0.1% to about 0.5% by weight of a photo acid generator, from about 2% to about 10% by weight of a photosensitive resin, and a residual of a solvent, the photosensitive resin including a blocking group having a weight average molecular weight of from about 70 to about 130 and a weight average molecular weight of from about 80 to about 120, said blocking group utilizes an activation energy (Ea) of not more than about 20 kcal/mol;
forming a photoresist film on an object by coating the photoresist composition;
selectively exposing the photoresist film using an illumination light; and
developing the selectively exposed photoresist film to thereby form a photoresist pattern.
